(19) United States
(12) Patent Application Publication
(10) Pub. No.: US 2019/0176699 A1
(43) Pub. Date: Jun. 13, 2019

(54) METHOD OF HITCHING A TOW VEHICLE TO A TRAILER, AND VEHICLE THEREFOR

(71) Applicant: GM GLOBAL TECHNOLOGY OPERATIONS LLC, Detroit, MI (US)

(72) Inventors: Mohammad Naserian, Windsor (CA); Allan K. Lewis, Windsor (CA)

(73) Assignee: GM GLOBAL TECHNOLOGY OPERATIONS LLC, Detroit, MI (US)

(21) Appl. No.: 15/836,233

(22) Filed: Dec. 8, 2017

(51) Int. Cl. B60R 1/02; B60R 1/06; B60R 11/04; B60W 50/14; B60W 30/095

(52) U.S. Cl. CPC B60R 1/025; B60R 1/06; B60R 11/04; B60W 50/14; B60W 2050/146; B60R 2300/301; B60R 2300/605; B60R 2300/808; B60W 30/095

(57) ABSTRACT

A method of hitching a tow vehicle to a trailer includes determining a distance between a coupler on the trailer and a hitch on the tow vehicle. A video of the coupler on the trailer is captured with the rearview camera, and displayed on a display screen of the tow vehicle. The tailgate and the rearview camera are positioned in a generally upright first position when the determined distance between the coupler on the trailer and the hitch on the tow vehicle is greater than a predefined distance. The tailgate and the rearview camera are positioned in a partially lowered second position when the determined distance between the coupler on the trailer and the hitch on the tow vehicle is equal to or less than the predefined distance to provide a better perspective of the hitch and coupler.

### INTRODUCTION

The disclosure generally relates to a method of hitching a tow vehicle to a trailer, and a vehicle operable to implement the method.

Tow vehicles are coupled to trailers through interlocking engagement of a hitch on the tow vehicle, and a coupler on the trailer. There are several different types and/or configurations of hitches and couplers used, but the process for connecting the hitch to the coupler, regardless of the type of hitch/coupler, includes backing the tow vehicle up to the trailer to position the hitch on the tow vehicle in proper position relative to the trailer so that the coupler may engage the hitch. This is a challenging task, and for many hitch/coupler configurations, the hitch and coupler are out of view of the tow vehicle operator.

In order to maneuver the tow vehicle into the proper position to connect the hitch to the coupler, the tow vehicle operator may rely on an assistant located outside of the tow vehicle to guide them into position. In order to simplify the hitching process, some tow vehicles have incorporated rearview cameras, which capture an image facing rearward of the tow vehicle. The image captured from the rearview camera is displayed on a display screen for the tow vehicle operator to see. However, when the tow vehicle gets close to the trailer, the coupler on the trailer often goes below and out of the field of view of the rearview camera, or due to the extreme angle, the depth perception provided by the captured video becomes very skewed, such that the tow vehicle operator must get out of the vehicle and verify the actual distance between the hitch and the coupler.

### SUMMARY

A vehicle is provided. The vehicle includes a body that extends along a central longitudinal axis, between a forward end and a rearward end. The body includes a tailgate that is disposed at the rearward end of the body. The tailgate is moveable between a first position and a second position. A hitch is attached to the body adjacent the rearward end of the body. The hitch is configured for connection to a coupler on a trailer. A rearview camera is mounted to and moveable with the tailgate. The rearview camera includes a field of view that changes perspective with movement of the tailgate between the first position and the second position. A vehicle controller includes a processor and a memory. The memory has a coupler viewing algorithm stored thereon. The processor is operable to execute the coupler viewing algorithm to assist in a method hitching the vehicle to the trailer. More specifically, the processor is operable to execute the coupler viewing algorithm to determine a distance between the coupler on the trailer and the hitch. The coupler viewing algorithm moves the tailgate and the rearview camera from the first position into the second position when the determined distance between the coupler on the trailer and the hitch is equal to or less than a predefined distance.

In one aspect of the vehicle, the processor is operable to execute the coupler viewing algorithm to capture a video of the coupler with the rearview camera. The coupler viewing algorithm further displays the captured video on a display screen of the vehicle.

In another aspect of the vehicle, the processor is operable to execute the coupler viewing algorithm to identify the coupler on the trailer in the captured video, and indicate a message that the tailgate may be lowered.

In another aspect of the vehicle, the vehicle includes a transmission that is selectively positionable in a reverse drive mode. The processor is operable to execute the coupler viewing algorithm to determine if the transmission is positioned in the reverse drive mode, or if the transmission is not positioned in the reverse drive mode.

In another aspect of the vehicle, the coupler viewing algorithm is operable to determine if the determined distance between the coupler on the trailer and the hitch is greater than the predefined distance, or if the determined distance between the coupler on the trailer and the hitch is equal to or less than the predefined distance.

In another aspect of the vehicle, the processor is operable to execute the coupler viewing algorithm to identify an object in a path of the tailgate that may interfere with movement of the tailgate from the first position into the second position.

In another aspect of the vehicle, the vehicle includes a tailgate actuator that interconnects the tailgate and the body. The tailgate actuator is operable to move the tailgate between the first position and the second position in response to a control signal.

A method of hitching a tow vehicle to a trailer is also provided. The method includes providing the tow vehicle with a rearview camera mounted on a tailgate. The rearview camera is moveable with the tailgate between a first position and a second position. A distance between a coupler on the trailer and a hitch on the tow vehicle is determined with a vehicle controller. A video of the coupler on the trailer is captured with the rearview camera. The captured video is displayed on a display screen of the tow vehicle. The tailgate and the rearview camera are moved from the first position into the second position when the determined distance between the coupler on the trailer and the hitch on the tow vehicle is equal to or less than a predefined distance.

The tow vehicle includes a transmission that is selectively positionable in either a reverse drive mode, or a non-reverse drive mode. In one aspect of the method, the vehicle controller determines if the transmission of the tow vehicle is positioned in the reverse drive mode, or if the transmission is not positioned in the reverse drive mode.

In one aspect of the method, when the transmission of the tow vehicle is positioned in the reverse drive mode, the method includes activating a coupler viewing algorithm operable on the vehicle controller of the tow vehicle. In another aspect of the method, the method includes deactivating the coupler viewing algorithm. Deactivating the coupler viewing algorithm may include an operator of the tow vehicle commanding the vehicle controller to deactivate the coupler viewing algorithm, or the operator of the tow vehicle positioning the transmission of the tow vehicle in a mode other than the reverse drive mode. In another aspect of the method, the vehicle controller may move the tailgate and the rearview camera from the second position to the first position in response to deactivation of the coupler viewing algorithm.

In another aspect of the method of hitching the tow vehicle to the trailer, the vehicle controller indicates a message that the tailgate may be lowered.

In another aspect of the method of hitching the tow vehicle to the trailer, the vehicle controller identifies the coupler on the trailer in the captured video. The vehicle controller may determine if the determined distance between the coupler on the trailer and the hitch on the tow vehicle is greater than the predefined distance, or if the determined distance between the coupler on the trailer and the hitch on the tow vehicle is equal to or less than the predefined distance.

In another aspect of the method, positioning the tailgate and the rearview camera in the second position when the determined distance between the coupler on the trailer and the hitch on the tow vehicle is equal to or less than the predefined distance, includes moving the tailgate and the rearview camera from the first position to the second position when the determined distance is reduced to the predefined distance. Moving the tailgate and the rearview camera from the first position to the second position may include automatically engaging a tailgate actuator of the tow vehicle, with the vehicle controller, to move the tailgate and the rearview camera. In an alternative embodiment, the vehicle controller may indicate a signal requesting the operator of the tow vehicle manually lower the tailgate and the rearview camera from the first position to the second position.

In another aspect of the method, the vehicle controller may identify an object in a path of the tailgate that may interfere with movement of the tailgate from the first position into the second position.

Accordingly, the method of hitching the tow vehicle to the trailer, which may be implemented by the vehicle described above, includes positioning the tailgate and the rearview camera in the second position when the tow vehicle is close to the trailer. The first position of the tailgate may be defined as a generally vertical or upright position, whereas the second position may be defined as a lowered or partially lowered position of the tailgate, in which the tailgate forms an acute angle relative to a horizontal plane. By moving the tailgate and the rearview camera into the second position as the tow vehicle nears the trailer, the perspective of the field of view of the rearview camera is changed to provide a more top-down view of the hitch and coupler, which provides a better perspective for the operator of the tow vehicle, thereby improving the hitching process.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a tow vehicle and a trailer, with a tailgate of the tow vehicle in a first position.

FIG. 2 is a schematic side view of the tow vehicle and the trailer, with the tailgate in a second position.

FIG. 3 is a flowchart representing a method of hitching the tow vehicle to the trailer.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

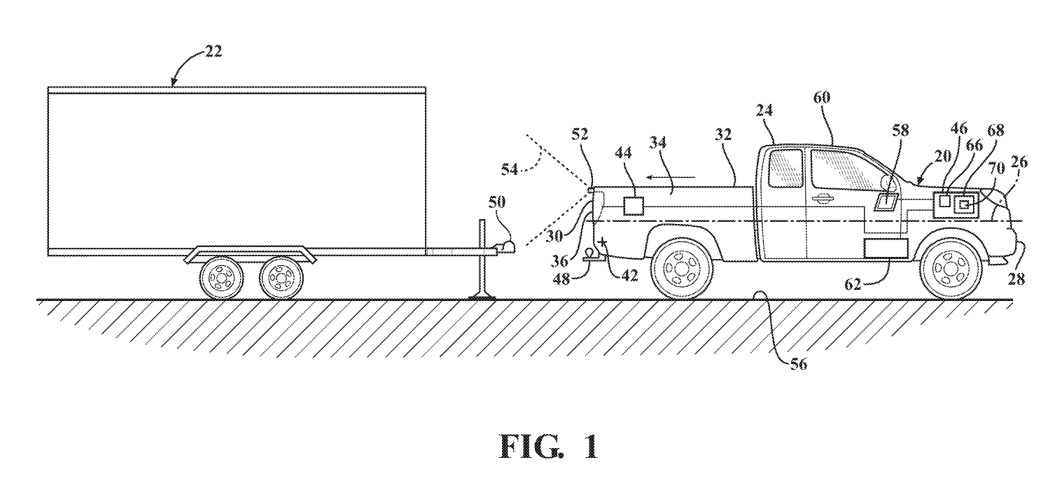

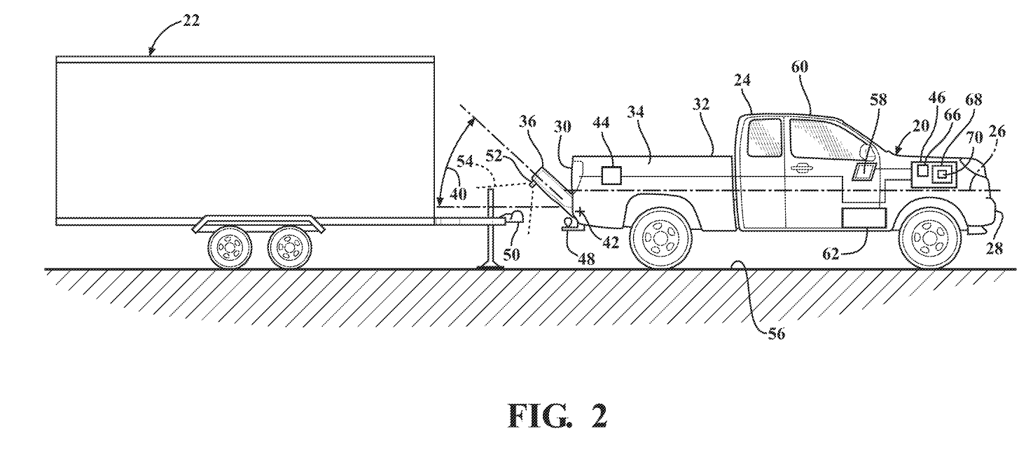

Referring to the FIGS., wherein like numerals indicate like parts throughout the several views, a vehicle is generally shown at 20. The exemplary embodiment of the vehicle 20 shown in the FIGS. is embodied as a pick-up truck. However, it should be appreciated that other embodiments of the vehicle 20 may be configured differently than the exemplary embodiment shown and described herein. As shown in FIGS. 1 and 2, the vehicle 20 is shown near a trailer 22.

Referring to FIGS. 1 and 2, the vehicle 20 includes a body 24, which extends along a central longitudinal axis 26 between a forward end 28 and a rearward end 30. As used herein, the body 24 of the vehicle 20 includes, but is not limited to, the panels forming the exterior shape of the vehicle 20, and the underlying support structure and framework to which the panels are attached. As shown in the exemplary embodiment, the body 24 includes a truck bed 32 having side walls 34 and a tailgate 36. The tailgate 36 is disposed at the rearward end 30 of the body 24. The tailgate 36 is rotatably attached to the truck bed 32 for rotation between a first position (shown in FIG. 1) and a second position (shown in FIG. 2). The first position may be defined as a closed position, in which the tailgate 36 is disposed in a generally vertical or upright orientation relative to a horizontal plane of the vehicle 20. The horizontal plane of the vehicle 20 may be defined as a plane defined by the central longitudinal axis 26 and a central transverse axis of the vehicle 20. The second position may be defined as an open position, in which the tailgate 36 is not disposed in the first position. The second position may include a position in which the tailgate 36 forms an acute angle 40 relative to the horizontal plane of the vehicle 20. When positioned in the first position, the tailgate 36 may be latched to the truck bed 32 to secure the tailgate 36 in position relative to the truck bed 32. Upon being unlatched, the tailgate 36 may rotate rearward about a rotation axis 42 to a fully opened position (not shown), in which the tailgate 36 is generally parallel with the horizontal plane of the vehicle 20. The second position may include a position of the tailgate 36 other the first position, i.e., between the first position and the fully opened position. Additionally, the second position may include and be defined as the fully opened position.

In other embodiments, the first position may be defined as a position in which the tailgate 36 forms a first angle relative to the horizontal plane, and the second position may be defined as a position in which the tailgate 36 forms a second angle relative to the horizontal plane, with the first angle being greater or larger than the second angle. In other words, the first position is a more upright position, and the second position is a more lowered position.

The vehicle 20 may include a tailgate actuator 44. The tailgate actuator 44 interconnects the tailgate 36 and the body 24. The tailgate actuator 44 is operable to move the tailgate 36 between the first position and the second position in response to a control signal from a vehicle controller 46. The tailgate actuator 44 may include a device or system capable of moving the tailgate 36. For example, the tailgate actuator 44 may include, but is not limited to, an electric motor for winding a cable. The electric motor is engaged in response to the control signal to wind or unwind the cable, which in turn raises or lowers the tailgate 36. It should be appreciated that the tailgate actuator 44 may include some other structure, device, system, etc., other than the exemplary embodiment noted above. The specific type, construction, and operation of the tailgate actuator 44 are not pertinent to the teachings of this disclosure, are understood by those skilled in the art, and are therefore not described in detail herein.

A hitch 48 is attached to the body 24 of the vehicle 20. The hitch 48 is disposed adjacent the rearward end 30 of the body 24, and is generally positioned underneath or at a lower elevation than the tailgate 36. The hitch 48 is configured for connection to a coupler 50 on the trailer 22. The hitch 48 and the coupler 50 may be configured in a suitable manner capable of securely coupling the trailer 22 to the truck. There are many different styles of hitch 48 and coupler 50. The specific type, style, configuration, and operation of the hitch 48 and the coupler 50 are not pertinent to the teachings of this disclosure, are understood by those skilled in the art, and are therefore not described in detail herein.

A rearview camera 52 is mounted to and moveable with the tailgate 36. The rearview camera 52 includes a field of view 54 that changes perspective with movement of the tailgate 36 between the first position and the second position. For example, when the tailgate 36 is disposed in the first position, the rearview camera 52 is facing generally rearward of the vehicle 20. However as the tailgate 36 rotates downward from the first position into the second position, the field of view 54 of the rearview camera 52 will also rotate downward. Accordingly, the further the tailgate 36 and the rearview camera 52 rotate away from the first position, the field of view 54 of the rearview camera 52 will change to a more downward direction. It should be appreciated, that when the tailgate 36 is in the fully closed position, the field of view 54 of the rearview camera 52 would be generally vertical, pointing downward toward a ground surface 56.

The rearview camera 52 may include a device capable of capturing and electronically communicating a picture and/or a video. The rearview camera 52 is connected with the vehicle controller 46, and transmits pictures/video to the vehicle controller 46. The rearview camera 52 may be used by other systems of the vehicle 20 as well, such as but not limited to an automatic driver assist function of the vehicle 20. The specific type, style, and operation of the rearview camera 52 are not pertinent to the teachings of this disclosure, are understood by those skilled in the art, and are therefore not described in detail herein.

The vehicle 20 further includes a display screen 58. In the exemplary embodiment shown in the FIGS., the display screen 58 is positioned within a cab 60 of the vehicle 20, and is viewable by an operator of the vehicle 20. The display screen 58 is disposed in communication with the vehicle controller 46, and displays the photo/video from the rearview camera 52. The display screen 58 may include a device capable of displaying a representation of the image(s) from the rearview camera 52. The specific type, style, and configuration of the display screen 58 are not pertinent to the teachings of this disclosure, are understood by those skilled in the art, and are therefore not described in detail herein.

The vehicle 20 further includes a transmission 62. The transmission 62 is selectively positionable in one of a plurality of drive modes. More specifically, the transmission 62 may be positioned in a reverse drive mode, or in a non-reverse drive mode. The transmission 62 may include a style of transmission suitable for the vehicle 20. For example, the transmission 62 may include, but is not limited to, an automatic transmission, a manual transmission, a dual clutch transmission, or a continuously variable transmission. An operator selects a desired drive mode for the transmission 62. Exemplary drive modes may include, but are not limited to, the reverse drive mode, a forward drive mode, a park mode, and a neutral mode. For the purposes of this disclosure, the drive modes of the transmission 62 may be considered the reverse drive mode, and the non-reverse drive modes. The non-reverse drive modes may include the available drive modes other than the reverse drive mode. The specific type, style and operation of the transmission 62 are not pertinent to the teachings of this disclosure, are understood by those skilled in the art, and are therefore not described in detail herein.

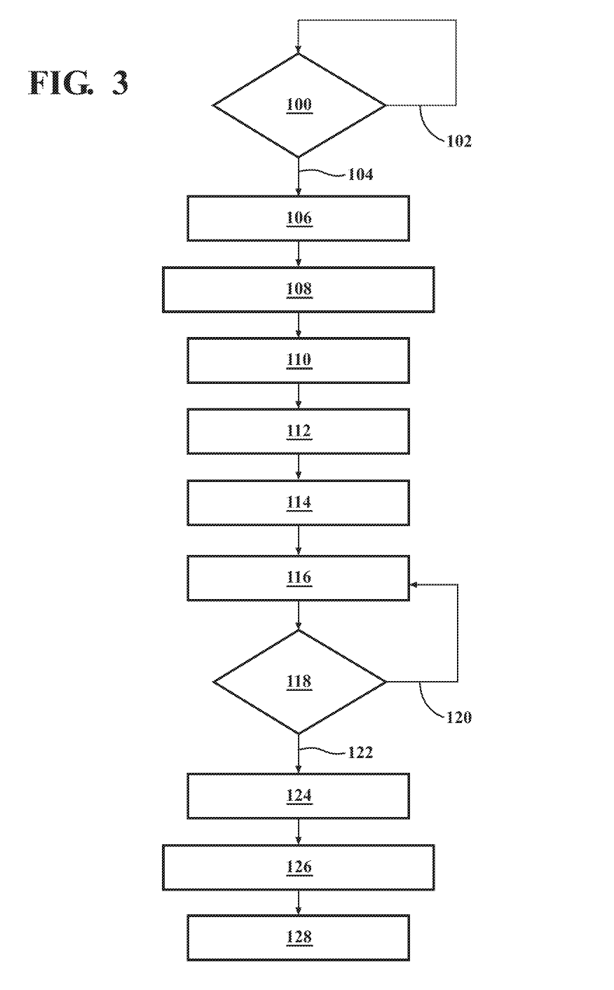

The vehicle controller 46 may be referred to as a controller, a vehicle 20 control module, a control module, a computing device, or a computer, etc. The vehicle controller 46 is operable to control certain components of the vehicle 20, such as but not limited to the rearview camera 52, the display screen 58, and the tailgate actuator 44. The vehicle controller 46 may include a computer and/or processor 66, and include software, hardware, memory, algorithms, connections, sensors, etc., for managing and controlling the operation of the vehicle 20. As such, a method described below and generally shown in FIG. 3 may be embodied as a program or algorithm operable on the vehicle controller 46. It should be appreciated that the vehicle controller 46 may include a device capable of analyzing data from various sensors, comparing data, making the decisions required to control the operation of the various components of the vehicle 20, and executing the required tasks for controlling the operation of the various components of the vehicle 20.

The vehicle controller 46 may be embodied as one or multiple digital computers or host machines each having one or more processors 66, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics.

The computer-readable memory may include a non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

The vehicle controller 46 includes tangible, non-transitory memory 68 on which are recorded computer-executable instructions, including a coupler viewing algorithm 70. The processor 66 of the vehicle controller 46 is configured for executing the coupler viewing algorithm 70. The coupler viewing algorithm 70 may be used to implement a method of hitching the vehicle 20 to the trailer 22. More specifically, the processor 66 is operable to execute the coupler viewing algorithm 70 to capture a video of the coupler 50 with the rearview camera, as the vehicle 20 backs up toward the trailer 22. As described below, the vehicle 20 may alternatively be referred to herein as the tow vehicle 20.

Referring to FIG. 3, the method of hitching the tow vehicle 20 to the trailer 22, as implemented by the coupler viewing algorithm 70, may include determining if the transmission 62 of the tow vehicle 20 is positioned in the reverse drive mode, or if the transmission 62 of the tow vehicle 20 is positioned in the non-reverse drive mode, i.e., if the transmission 62 is not positioned in the reverse drive mode. The step of determining if the transmission 62 is in the reverse drive mode is generally indicated by box 100 in FIG. 3. As is understood by those skilled in the art, the process of hitching the tow vehicle 20 to the trailer 22 includes backing or reversing the tow vehicle 20 up to the trailer 22, so that the hitch 48 on the tow vehicle 20 is properly aligned with the coupler 50 on the trailer 22. In order to ensure that the process described below is not inadvertently executed, the vehicle controller 46 may require that the transmission 62 of the vehicle 20 is positioned in the reverse drive mode, such as would be the position when backing the tow vehicle 20 up to the trailer 22. The vehicle controller 46 may determine the drive mode of the tow vehicle 20 in a suitable manner, such as by querying a transmission controller or a transmission control module of the vehicle 20.

If the vehicle controller 46 determines that the drive mode of the transmission 62 is in the non-reverse drive mode, i.e., is not in the reverse drive mode, generally indicated at 102 in FIG. 3, then the vehicle controller 46 ends the coupler viewing algorithm 70, and continues to monitor the position of the transmission 62 to determine when the transmission 62 is repositioned into the reverse drive mode. If the vehicle controller 46 determines that the transmission 62 of the vehicle 20 is positioned in the reverse drive mode, generally indicated at 104 in FIG. 3, then the vehicle controller 46 enables activation of the remaining processes of the coupler viewing algorithm 70.

If the vehicle controller 46 has determined that the transmission 62 of the vehicle 20 is positioned in the reverse drive mode, an operator of the tow vehicle 20 may then activate the coupler viewing algorithm 70. The step of activating the coupler viewing algorithm 70 is generally indicated by box 106 in FIG. 3. The operator may activate the coupler viewing algorithm 70 in a suitable manner, such as by inputting a command into the vehicle controller 46. The command may be input into the vehicle controller 46 in a suitable manner, such as but not limited to, pressing a button, toggle switch, etc., inputting the command via a touch screen display, a vocal command, or by some other input device. It should be understood by those skilled in the art that the coupler viewing algorithm 70 may be activated in many different ways using many different devices.

Upon activating the coupler viewing algorithm 70, the vehicle controller 46 may indicate a message that the tailgate 36 may be lowered. The step of indicating the tailgate moving down message is generally indicated by box 108 in FIG. 3. The message may be indicated in a suitable manner. For example, the vehicle controller 46 may display a written message on the display screen 58, may illuminate an indicator lamp, or may broadcast a vocal message. It should be appreciated that the message may be indicated in some other manner not specifically described herein, in order to warn the operator that the tailgate 36 may be lowered as part of the process described herein.

The vehicle controller 46 may then command the rearview camera 52 to capture a video of the coupler 50 on the trailer 22. The step of capturing video of the coupler 50 is generally indicated by box 110 in FIG. 3. It should be appreciated that the video is a compilation of images strung together to form a moving image. Accordingly, it should be appreciated that capturing the video of the coupler 50 includes capturing a single image of the coupler 50. The rearview camera 52 captures the video with the tailgate 36 in the first position, i.e., the upright generally vertical position. The vehicle controller 46 may then display the captured video on the display screen 58 of the tow vehicle 20, so that the operator of the tow vehicle 20 may view the image during the hitching process. The step of displaying the video is generally indicated by box 112 in FIG. 3.

The vehicle controller 46 then identifies the coupler 50 on the trailer 22 in the captured video. The step of identifying the coupler 50 in the video is generally indicated by box 114 in FIG. 3. The vehicle controller 46 may identify the coupler 50 in a suitable manner. For example, the vehicle controller 46 may use feature recognition software to identify the coupler 50 on the trailer 22. Alternatively, the vehicle controller 46 may identify the coupler 50 in the video in some other manner not described herein.

Once the vehicle controller 46 has identified the coupler 50 on the trailer 22, then the vehicle controller 46 may determine a distance between the coupler 50 on the trailer 22 and the hitch 48 on the tow vehicle 20. The step of determining the distance between the coupler 50 and the hitch 48 is generally indicated by box 116 in FIG. 3. The vehicle controller 46 may determine the distance to the coupler 50 in a suitable manner. For example, the vehicle controller 46 may use a distance calculation software to determine the distance to the coupler 50. This may require certain information be input into the vehicle controller 46, such as the location of the hitch 48 relative to the rearview camera 52. Alternatively, if both the hitch 48 and the coupler 50 are visible in the captured video, then the vehicle controller 46 may use these two features to capture the distance therebetween.

The vehicle controller 46 then compares the determined distance between the coupler 50 and the hitch 48 to a predefined distance. The predefined distance may be defined to include a value that is dependent upon the specific configuration of the tow vehicle 20 and the trailer 22. For example, the predefined distance may be defined as the distance between the hitch 48 and the coupler 50 where the coupler 50 goes out of the field of view 54 of the rearview camera 52 when positioned in the first position, or where the location of the coupler 50 in the captured video becomes too distorted for the operator to view. The vehicle controller 46 compares the determined distance to the predefined distance to determine if the determined distance between the coupler 50 on the trailer 22 and the hitch 48 is greater than the predefined distance, or if the determined distance between the coupler 50 on the trailer 22 and the hitch 48 is equal to or less than the predefined distance. The step of determining if the determined distance is greater than, equal to, or less than the predefined distance is generally indicated by box 118 in FIG. 3.

If the vehicle controller 46 determines that the determined distance is greater than the predefined distance, generally indicated at 120 in FIG. 3, then the vehicle controller 46 maintains the position of the tailgate 36 and the rearview camera 52 in the first position, such as shown in FIG. 1, and continues to determine the distance between the hitch 48 and the coupler 50 as the tow vehicle 20 nears the trailer 22. The operator may move the tow vehicle 20 toward the trailer 22 to reduce the determined distance between the coupler 50 on the trailer 22 and the hitch 48 on the tow vehicle 20.

If the vehicle controller 46 determines that the determined distance is equal to or less than the predefined distance, such as shown in FIG. 2 and generally indicated at 122 in FIG. 3, then the vehicle controller 46 positions the tailgate 36 and the rearview camera 52 in the second position. However, prior to positioning the tailgate 36 and the rearview camera 52 in the second position, the vehicle controller 46 may determine or identify an object in a path of the tailgate 36 that may interfere with movement of the tailgate 36 from the first position into the second position. The step of identifying an obstructing object is generally indicated by box 124 in FIG. 3. The vehicle controller 46 may identify an object in the path of the tailgate 36 in a suitable manner. For example, the vehicle controller 46 may use object recognition software to examine the captured video, or proximity sensors, in order to identify a potential object that may interfere with the tailgate 36. It should be appreciated that the object may be identified in some other manner as well, not specifically mentioned or described herein.

Once the vehicle controller 46 determines that the path of the tailgate 36 is clear of an obstructing object, then the vehicle controller 46 may move the tailgate 36 and the rearview camera 52 from the first position into the second position. The step of moving the tailgate 36 into the second position is generally indicated by box 126 in FIG. 3. It should be appreciated that the operator may be moving the tow vehicle 20 closer to the trailer 22 during the process. As such, the vehicle controller 46 may move the tailgate 36 and the rearview camera 52 from the first position to the second position when the determined distance is reduced to a value that equals the predefined distance.

The tailgate 36 and the rearview camera 52 may be moved from the first position into the second position in a suitable manner. For example, moving the tailgate 36 and the rearview camera 52 from the first position to the second position may include the vehicle controller 46 automatically engaging the tailgate actuator 44 of the tow vehicle 20 to move the tailgate 36 and the rearview camera 52 from the first position into the second position. Alternatively, moving the tailgate 36 and the rearview camera 52 from the first position to the second portion may include signaling the operator to manually move the tailgate 36 from the first position to the second position. In order to do so, the vehicle 20 may be equipped with a catch or shortened cable that secures the tailgate 36 relative to the body 24 in the desired second position. The operator may manually position the tailgate 36 in the second position.

As noted above, the rearview camera 52 includes a field of view 54. As the tow vehicle 20 nears the trailer 22, the coupler 50 on the trailer 22 may go outside the field of view 54 of the rearview camera 52, or may become distorted to the point that the operator is unable to properly judge the location of the coupler 50 relative to the hitch 48. By moving the tailgate 36 and the rearview camera 52 from the first position, i.e., the generally vertical or upright position, into the second position, i.e., the fully or partially lowered position, the field of view 54 of the rearview camera 52 is moved as well, and provides an more top down view of the coupler 50, so that the operator may better judge the position of the coupler 50 relative to the hitch 48 in the captured video displayed on the display screen 58.

Although the process has been described above with reference to a single second position and a single predefined distance, it should be appreciated that the above described process may be implemented using several different positions of the tailgate 36 for different distances between the coupler 50 and the hitch 48. In other words, as the tow vehicle 20 approaches the trailer 22, the tailgate 36 may be lowered to a first sequential position at a first predefined distance, followed by lowering the tailgate 36 to a second sequential position at a second predefined distance, followed by lowering the tailgate 36 to a third sequential position at a third predefined distance, etc. Accordingly, it should be appreciated that the second position may be defined as several distinct sequential positions, with each of the sequential positions having a respective predefined distance.

The coupler viewing algorithm 70 may be deactivated when desired during the process. The step of deactivating the coupler viewing algorithm 70 is generally indicated by box 128 in FIG. 3. For example, the coupler viewing algorithm 70 may be deactivated by the operator commanding the vehicle controller 46 to deactivate the coupler viewing algorithm 70, such as by pressing a button, toggle switch, inputting a command into a touch screen display, a vocal command, etc. The operator may deactivate the coupler viewing algorithm 70 at their discretion. Alternatively, the vehicle controller 46 may automatically deactivate the coupler viewing algorithm 70 in response to the operator positioning the transmission 62 in a non-reverse drive mode. For example, when the operator determines that the hitch 48 is properly positioned relative to the coupler 50, the operator may reposition the transmission 62 of the vehicle 20 from the reverse drive mode into the park mode, i.e., the non-reverse drive mode. In response to the operator placing the transmission 62 in the non-reverse drive mode, the vehicle controller 46 may deactivate the coupler viewing algorithm 70. Deactivation of the coupler viewing algorithm 70 may include the vehicle controller 46 automatically moving the tailgate 36 and the rearview camera 52 from the second position, back into the first position.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A vehicle comprising:
a body extending along a central longitudinal axis between a forward end and a rearward end;
wherein the body includes a tailgate disposed at the rearward end of the body, and moveable between a first position and a second position;
a hitch attached to the body adjacent the rearward end of the body, and configured for connection to a coupler on a trailer;
a rearview camera mounted to and moveable with the tailgate, wherein the rearview camera includes a field of view that changes perspective with movement of the tailgate between the first position and the second position; and
a vehicle controller including a processor and a memory having a coupler viewing algorithm stored thereon, wherein the processor is operable to execute the coupler viewing algorithm to:
determine a distance between the coupler on the trailer and the hitch; and
move the tailgate and the rearview camera from the first position into the second position when the determined distance between the coupler on the trailer and the hitch is equal to or less than a predefined distance.

2. The vehicle set forth in claim 1, wherein the processor is operable to execute the coupler viewing algorithm to capture a video of the coupler with the rearview camera.

3. The vehicle set forth in claim 2, further comprising a display screen, wherein the processor is operable to execute the coupler viewing algorithm to display the captured video on the display screen.

4. The vehicle set forth in claim 2, wherein the processor is operable to execute the coupler viewing algorithm to identify the coupler on the trailer in the captured video.

5. The vehicle set forth in claim 1, further comprising a transmission selectively positionable in a reverse drive mode, wherein the processor is operable to execute the coupler viewing algorithm to determine if the transmission is positioned in the reverse drive mode, or if the transmission is not positioned in the reverse drive mode.

6. The vehicle set forth in claim 1, wherein the processor is operable to execute the coupler viewing algorithm to indicate a message that the tailgate may be lowered.

7. The vehicle set forth in claim 1, wherein the processor is operable to execute the coupler viewing algorithm to determine if the determined distance between the coupler on the trailer and the hitch is greater than the predefined distance, or if the determined distance between the coupler on the trailer and the hitch is equal to or less than the predefined distance.

8. The vehicle set forth in claim 1, further comprising a tailgate actuator interconnecting the tailgate and the body, and operable to move the tailgate between the first position and the second position in response to a control signal.

9. The vehicle set forth in claim 1, wherein the processor is operable to execute the coupler viewing algorithm to identify an object in a path of the tailgate that may interfere with movement of the tailgate from the first position into the second position.

10. A method of hitching a tow vehicle to a trailer, the method comprising:
providing the tow vehicle with a rearview camera mounted on a tailgate, wherein the rearview camera is moveable with the tailgate between a first position and a second position;
determining a distance between a coupler on the trailer and a hitch on the tow vehicle, with a vehicle controller;
capturing a video of the coupler on the trailer with the rearview camera;
displaying the captured video on a display screen of the tow vehicle; and
moving the tailgate and the rearview camera from the first position into the second position when the determined distance between the coupler on the trailer and the hitch on the tow vehicle is equal to or less than a predefined distance.

11. The method set forth in claim 10, further comprising determining if a transmission of the tow vehicle is positioned in a reverse drive mode, or if the transmission is not positioned in the reverse drive mode.

12. The method set forth in claim 11, further comprising activating a coupler viewing algorithm operable on the vehicle controller of the tow vehicle when the transmission of the tow vehicle is positioned in the reverse drive mode.

13. The method set forth in claim 12, further comprising deactivating the coupler viewing algorithm, wherein deactivating the coupler viewing algorithm includes an operator commanding the vehicle controller to deactivate the coupler viewing algorithm, or the operator positioning the transmission of the tow vehicle in a mode other than the reverse drive mode.

14. The method set forth in claim 13, further comprising moving the tailgate and the rearview camera from the second position to the first position in response to deactivation of the coupler viewing algorithm.

15. The method set forth in claim 10, further comprising indicating a message that the tailgate may be lowered.

16. The method set forth in claim 10, further comprising identifying the coupler on the trailer in the captured video.

17. The method set forth in claim 10, further comprising determining if the determined distance between the coupler on the trailer and the hitch on the tow vehicle is greater than the predefined distance, or if the determined distance between the coupler on the trailer and the hitch on the tow vehicle is equal to or less than the predefined distance.

18. The method set forth in claim 10, wherein positioning the tailgate and the rearview camera in the second position when the determined distance between the coupler on the trailer and the hitch on the tow vehicle is equal to or less than the predefined distance includes moving the tailgate and the rearview camera from the first position to the second position when the determined distance is reduced to the predefined distance.

19. The method set forth in claim 18, wherein moving the tailgate and the rearview camera from the first position to the second position is further defined as automatically engaging a tailgate actuator of the tow vehicle, with the vehicle controller, to move the tailgate and the rearview camera.

20. The method set forth in claim 10, further comprising identifying an object in a path of the tailgate that may interfere with movement of the tailgate from the first position into the second position.
